(19) United States
(12) Patent Application Publication
(10) Pub. No.: US 2013/0166869 A1
(43) Pub. Date: Jun. 27, 2013

(54) UNLOCK A STORAGE DEVICE

(71) Applicants: Lan Wang, Cypress, TX (US); Valiuddin Y Ali, Cypress, TX (US); Jennifer E Rios, Spring, TX (US)

(72) Inventors: Lan Wang, Cypress, TX (US); Valiuddin Y Ali, Cypress, TX (US); Jennifer E Rios, Spring, TX (US)

(73) Assignee: HEWLETT-PACKARD DEVELOPMENT COMPANY, L.P., Fort Collins, CO (US)

(21) Appl. No.: 13/821,000

(22) PCT Filed: Sep. 10, 2010
(86) PCT No.: PCT/US10/48395

§ 371 Date: Mar. 5, 2013

(51) Int. Cl. G06F 12/14

(52) U.S. Cl. CPC G06F 12/1466
USPC 711/163

(57) ABSTRACT

Unlocking a storage device including identifying a platform configuration register value in response to a computing machine powering on, configuring a security component to seal an authorization based on the platform configuration register value and storing a sealed authorization onto non-volatile memory, and unlocking the storage device in response to the computing machine resuming from a sleep state and unsealing the sealed authorization with the security component from the non-volatile memory.

### BACKGROUND

When accessing a storage device coupled to a computing machine, a user can power on the computing machine and proceed to enter a user password into an operating system of the computing machine. Once the user password has been authenticated, contents of the storage device can be accessed. Additionally, if the computing machine powers off or enters into a low powered state, the user can power on the computing machine again and the user can be re-authenticated by reentering the user password in order to access the storage device again.

### BRIEF DESCRIPTION OF THE DRAWINGS

Various features and advantages of the disclosed embodiments will be apparent from the detailed description which follows, taken in conjunction with the accompanying drawings, which together illustrate, by way of example, features of the disclosed embodiments.

FIG. 1 illustrates a computing machine coupled to a storage device according to an embodiment.

FIG. 2 illustrates a storage device with a locking mechanism and a security component coupled to a computing machine according to an embodiment.

FIG. 3A illustrates a block diagram of a storage application unlocking a storage device in response to a computing machine powering on according to an embodiment.

FIG. 3B illustrates a block diagram of a storage application unlocking a storage device in response to a computing machine powering on according to another embodiment.

FIG. 4A illustrates a block diagram of a storage device locking in response to a computing machine entering a sleep state according to an embodiment.

FIG. 4B illustrates a block diagram of a storage device unlocking in response to a computing machine resuming from a sleep state according to an embodiment.

FIG. 4C illustrates a block diagram of a storage device unlocking in response to a computing machine resuming from a sleep state according to another embodiment.

FIG. 5 illustrates a storage application on a computing machine and a storage application stored on a removable medium being accessed by the computing machine according to an embodiment.

FIG. 6 is a flow chart illustrating a method for unlocking a storage device according to an embodiment.

FIG. 7 is a flow chart illustrating a method for unlocking a storage device according to another embodiment.

### DETAILED DESCRIPTION

By identifying a platform configuration value in response to a computing machine powering on, a security component can securely seal an authorization for a storage device onto non-volatile memory of the computing machine based on the platform configuration value. Additionally, by unsealing the authorization from the non-volatile memory using the security component in response to the computing machine resuming from a sleep state, the storage device can efficiently be unlocked for use. As a result, a user friendly experience can be created for a user when accessing the storage device.

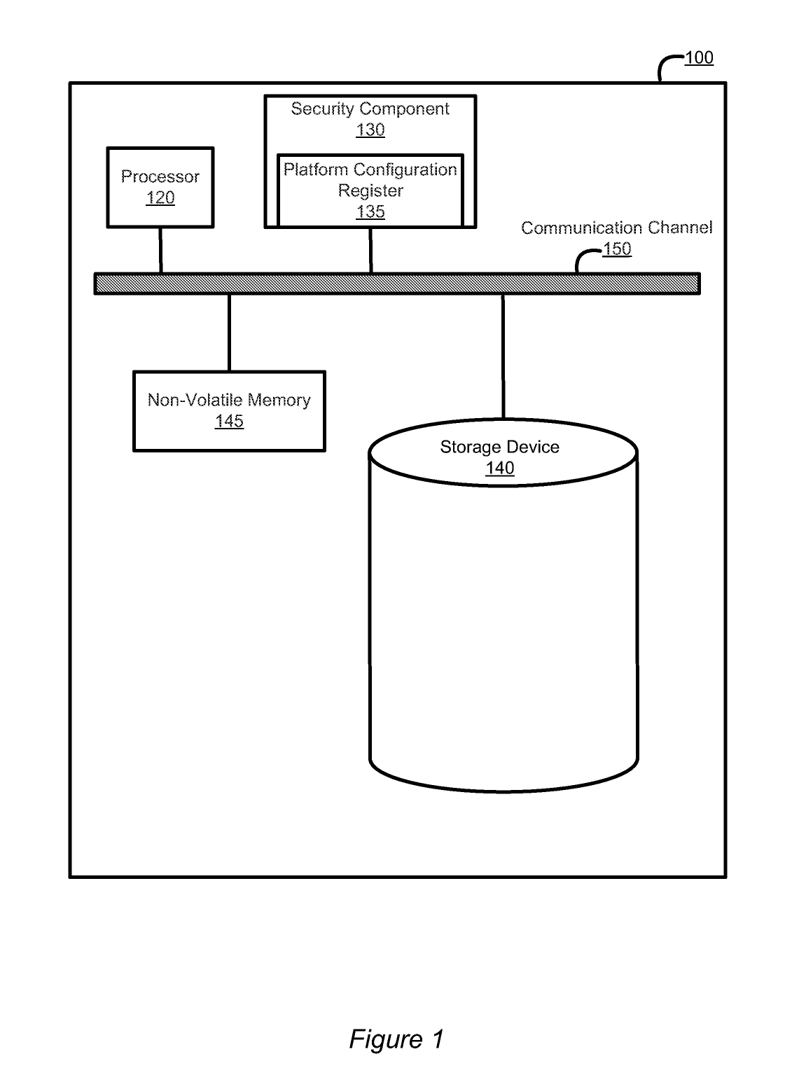

FIG. 1 illustrates a computing machine 100 coupled to a storage device 140 according to an embodiment. In one embodiment, the computing machine 100 can be a desktop, a laptop, a tablet, a netbook, an all-in-one system, a server and the like. In another embodiment, the computing machine 100 can be a cellular device, a PDA (Personal Digital Assistant), and/or any additional computing machine which can include a storage device 140.

As illustrated in FIG. 1, the computing machine 100 includes a processor 120, a security component 130, a storage device 140, non-volatile memory 145, and a communication channel 150 for the computing machine 100 and/or one or more components of the computing machine 100 to communicate with one another. As shown in FIG. 1, the security component 130 includes one or more platform configuration registers 135. In one embodiment, the storage device 140 can be configured to include a storage application. In other embodiments, the computing machine 100 can include additional components and/or is coupled to additional components in addition to and/or in lieu of those noted above and illustrated in FIG. 1.

As noted above, the computing machine 100 includes a processor 120. The processor 120 can send data and/or instructions to the components of the computing machine 100, such as the security component 130, the storage device 140, and the storage application. Additionally, the processor 120 reads or receives data and/or instructions from components of the computing machine 100, such as the security component 130, the storage device 140, and the storage application.

The storage application is an application which can be utilized in conjunction with the processor 120 to control or manage a storage device 140 in response to the computing machine 100 entering or transitioning between a power on state, power off state, and/or a sleep state. For the purposes of this application; the storage device 140 is a component of the computing machine 100 which stores data and/or content. The storage device 140 can include an IDE (Integrated Drive Electronics) drive, a SSD (Solid State) drive, a SATA (Serial Advanced Technology Attachment) drive, an ESATA (External Serial Advanced Technology Attachment) drive, a PATA (Parallel Advanced Technology Attachment) drive, a USB (Universal Serial Bus) drive, a 1394 (Firewire) drive, and/or any component which can store content and/or data.

Additionally, the storage device 140 can include an internal or external drive configured to couple and interface with the computing machine 100 through one or more interfaces. When managing the storage device 140, the processor 120 and/or the storage application configure the storage device 140 to lock or unlock in response to the computing machine 100 entering and/or transitioning between one or more of the power states.

The storage device 140 can be locked and/or unlocked using a locking mechanism. The locking mechanism can include a software, firmware, hardware, and/or mechanical component configured to restrict access to data and content on the storage device 140. When the locking mechanism is engaged, the storage device 140 can be locked and access to data and/or content of the storage device 140 can be restricted. Additionally, when the locking mechanism is disengaged, the storage device 140 can be unlocked and data and/or content of the storage device 140 can be accessible.

When unlocking the storage device 140, the processor 120 and/or the storage application can use an authorization to disengage the locking mechanism. The authorization can be entered as a password by a user of the computing machine 100 in response to the computing machine 100 entering a power on state. In one embodiment, the authorization can further be encrypted and stored in one or more locations of the computing machine 100.

In response to the computing machine 100 entering a power on state, the processor 120 and/or the storage application can read an initial value of a platform configuration register 135. For the purposes of this application, the platform configuration register 135 includes an area of memory within the security component 130 configured to generate and store one or more data or values in response to the computing machine 100 powering on. The security component 130 is a software or hardware component of the computing machine 100 configured to generate cryptographic keys used to protect and/or seal data and passwords. In one embodiment, the security component 130 includes a trusted platform module.

In response to identifying an initial value of the platform configuration register 135, the processor 120 and/or the storage application proceed to configure the security component 130 to seal the authorization based on the initial value of the platform configuration register 135 and store the sealed authorization onto non-volatile memory 145. Once the sealed authorization has been stored onto non-volatile memory 145, the processor 120 and/or the storage application proceed to determine whether the computing machine 100 is entering a power off state, a hibernation state, or a sleep state. If the computing machine 100 enters into a power off state, a hibernation state, or a sleep state, the locking mechanism will proceed to lock the storage device 140.

Further, if the computing machine 100 proceeds to resume from the sleep state, the security component 130 will retrieve the sealed authorization from non-volatile memory 145 and unseal the authorization. Using the unsealed authorization, the processor 120 and/or the storage application will proceed to unlock the locking mechanism and the storage device 140 will become unlocked and accessible to the computing machine 100.

The storage application can be firmware which is embedded onto the processor 120, the computing machine 100, and/or the storage device 140. In another embodiment, the storage application is a BIOS (Basic Input/Output System) of the computing machine or the storage application is a software application stored on the computing machine 100 within ROM (Read Only Memory) or on the storage device 140 accessible by the computing machine 100. In other embodiments, the storage application is stored on a computer readable medium readable and accessible by the computing machine 100 or the storage device 140 from a different location.

The storage device 140 can be included in the computing machine 100. In other embodiments, the storage device 140 is not included in the computing machine 100, but is accessible to the computing machine 100 utilizing a network interface included in the computing machine 100. The network interface can be a wired or wireless network interface card. In other embodiments, the storage device 140 can be configured to couple to one or more ports or interfaces on the computing machine 100 wirelessly or through a wired connection.

In a further embodiment, the storage application is stored and/or accessed through a server coupled through a local area network or a wide area network. The storage application communicates with devices and/or components coupled to the computing machine 100 physically or wirelessly through a communication bus 150 included in or attached to the computing machine 100. In one embodiment the communication bus 150 is a memory bus. In other embodiments, the communication bus 150 is a data bus.

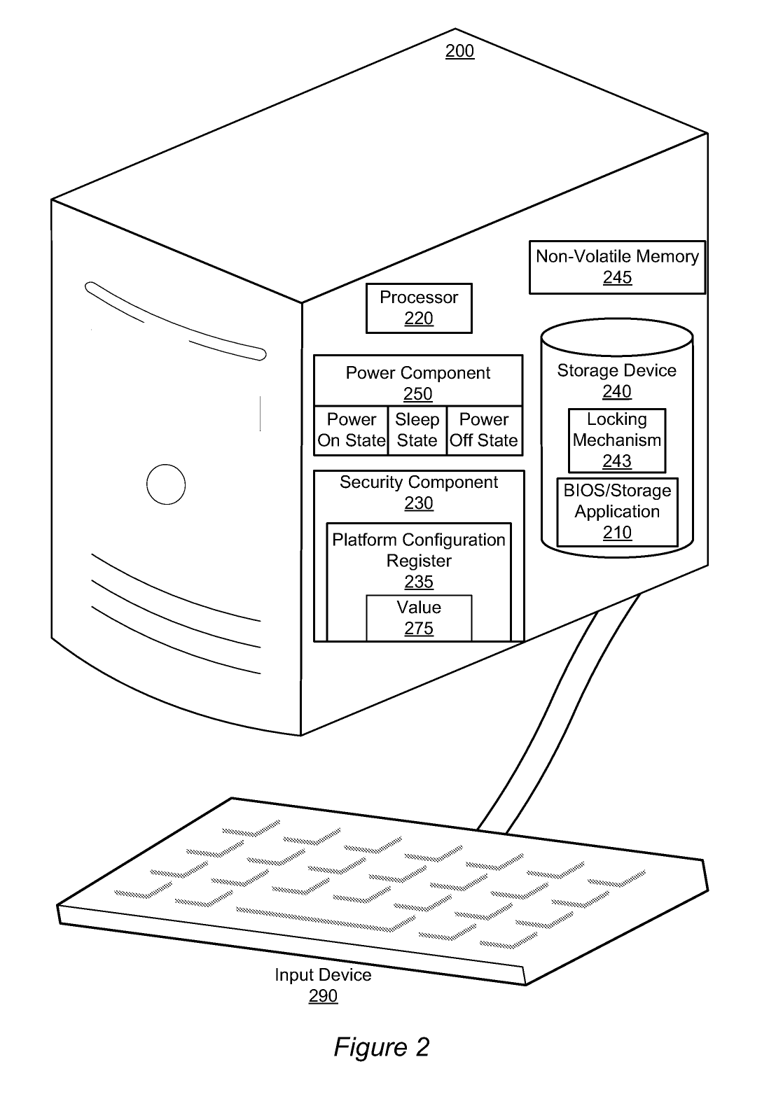

FIG. 2 illustrates a storage device 240 with a locking mechanism 243 and a security component 230 coupled to a computing machine 200 according to an embodiment. As noted above, the locking mechanism 243 can include a software, firmware, hardware, and/or mechanical component configured to engage when locking the storage device 240 and disengage when unlocking the storage device 240. In one embodiment, the locking mechanism 243 is initially engaged to lock the storage device 240 when the computing machine 200 is in a power off state. In another embodiment, the locking mechanism 243 is configured to engage and lock the storage device 240 in response to the computing machine 200 entering into a sleep state or a power off state.

When engaged, the locking mechanism 243 can prevent one or more platters of the storage device 240 from spinning. In another embodiment, the locking mechanism physically restricts access to one or more segments of the storage device 240. In other embodiments, the locking mechanism 243 encrypts the data and/or the content of the storage device 240 when engaged.

As noted above and as shown in FIG. 2, the computing machine 200 can include one or more power states. One or more of the power states include a power on state (G0), a power off state (G2 and/or G3), and/or a sleep state (S3 and/or S4). The computing machine 200 can enter and/or transition between one or more of the power states in response to a power component 250 of the computing machine 200 modifying an amount of power supplied to one or more components of the computing machine 200. The power component 250 is a device, such as a power supply, configured to manage an amount of power supplied to the computing machine 200 and/or one or more components of the computing machine 200.

When the computing machine 200 transitions into a power on state from the power off state, a processor 220 and/or a storage application 210 can initially attempt to unlock the storage device 240 by disengaging the locking mechanism 243. As noted above, an authorization can be used to disengage the locking mechanism 243 and unlock the storage device 240. The authorization can include a password, a key, and/or any additional secret which can be used to lock or unlock the storage device 240. Additionally, the authorization can further be encrypted using one or more keys and/or functions.

If the authorization includes a password, the password can include a sequence of numbers and/or characters which can be authenticated by the processor 220, a storage application 210, the locking mechanism 243, and/or the storage device 240. In another embodiment, if the authorization includes a key, the key can symmetrical or asymmetrical.

The authorization can be generated by the storage application 210 and/or the processor 220 using one or more functions, keys, and/or algorithms. In another embodiment, the authorization can be inputted by a user of the computing machine 200 using an input device 290. The input device 290 is a component of the computing machine 200 which a user of the computing machine 200 can use to enter the authorization to unlock the storage device 240.

In one embodiment, the input device 290 is a keyboard. In another embodiment, the input device 290 can be a mouse, a touch panel, a fingerprint scanner, an image capture device, and/or any additional component configured to detect or receive the authorization a user. Once the authorization has been detected, generated, and/or identified, the authorization will be authenticated and used to disengage the locking mechanism 243 and unlock the storage device 240.

In response to unlocking the storage device 240, the processor 220 and/or the storage application 210 proceed to seal the authorization using a security component 230. As noted above, the security component 230 is a software or hardware component configured by the processor 220 and/or the storage application 210 of the computing machine 200 to protect data or authorizations of the computing machine 200 by sealing and/or unsealing data and/or authorizations. In one embodiment, the security component 230 is a trusted platform module 230 and the trusted platform module 230 seals the authorization in response to the computing machine 200 powering on and the storage device 240 unlocking.

In another embodiment, the trusted platform module 230 additionally unseals the authorization in response to the computing machine 200 resuming from a sleep state. In other embodiments, additional security modules with properties similar to the security component 230 or the trusted platform module 230 can be used by the processor and/or the storage application 210 to seal one or more authorizations based on a value of a platform configuration register 235.

When performing a seal operation on the authorization, the security component 230 encrypts the authorization using one or more keys, functions, and/or encryption algorithms. In one embodiment, one or more keys, functions, and/or encryption algorithms can include a storage root key or security component key. Once the authorization has been sealed, the processor 220 and/or the storage application 210 will proceed to store the sealed authorization onto non-volatile memory 245 of the computing machine 200. The non-volatile memory 245 can include internal or external flash memory and/or any additional storage component of the computing machine 200.

When performing an unseal operation on the authorization, the processor 220 and/or the storage application 210 instruct the security component 230 to decrypt the authorization using one or more keys, functions, and/or decryption algorithms, such as the storage root key or the storage component key. The security component 230 seals and unseals the authorization based on an initial value 275 of a platform configuration register 235.

As illustrated in FIG. 2, the security component 230 can include one or more platform configuration registers 235. A platform configuration register 235 generates an initial value 275 in response to the computing machine 200 powering on from a power off state. Additionally, when the computing machine 200 resumes to a power on state from a sleep state, the platform configuration register 235 can generate the initial value 275 again.

As the computing machine 200 continues to continue a booting process of initializing components and loading an operating system, the platform configuration register 235 will generate additional values which are different from the initial value 275. As a result, the security component 230 performs the sealing and unsealing of the authorization based on the initial value 275 of the platform configuration register 235 when the computing machine 200 powers on and before the additional values are generated by the platform configuration register 235. Once the platform configuration register 235 has generated an initial value 275, the initial value 275 can be read by the processor 220 and/or the storage application 210 and stored onto a memory of the computing machine 200. The memory can include volatile or non-volatile memory 245.

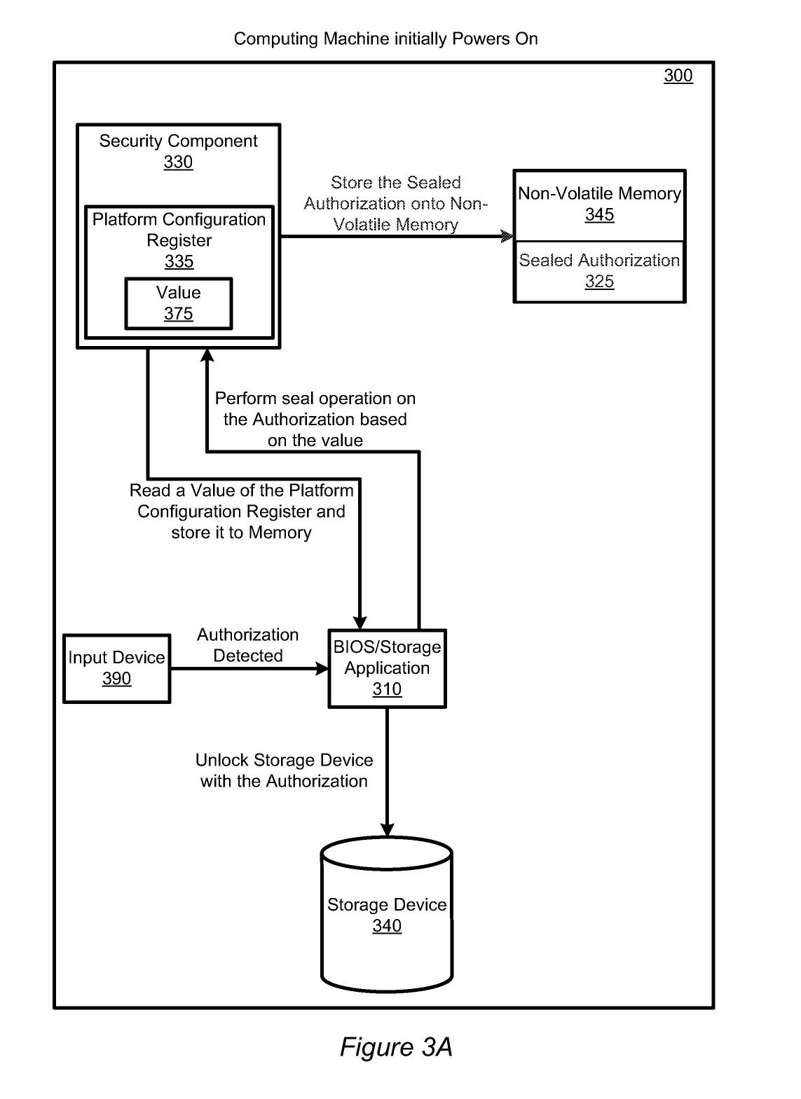

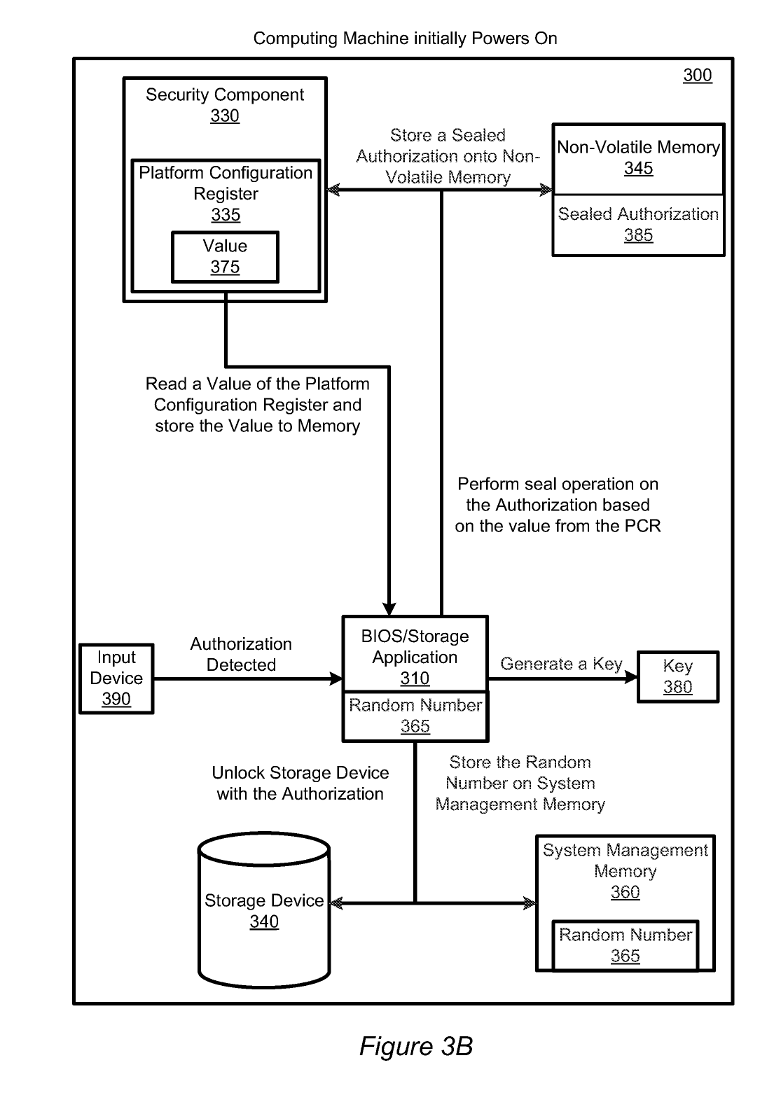

FIG. 3A illustrates a block diagram of a storage application 310 unlocking a storage device 340 in response to a computing machine 300 powering on according to an embodiment. As noted above, in response to the computing machine 300 entering a power on state from a power off state, the storage application 310 and/or a processor access a security component 330 to read an initial value 375 of a platform configuration register 335. In one embodiment, the storage application 310 and/or the processor have determined that the platform configuration register 335 generated an initial value 375 of X.

As illustrated in the present embodiment, in response to reading the initial value 375, the storage application 310 and/or the processor proceed to store the initial value 375 X to memory of the computing machine 300. Once the initial value 375 has been stored, the storage application 310 and/or the processor proceed to identify an authorization to unlock the storage device 340 with. As noted above, the authorization can include a password. In one embodiment; the storage application 310 and/or the processor will prompt a user to enter a password. As shown in the present embodiment, an input device 390 has detected a user entering a password.

In response to detecting the password, the storage application 310 and/or the processor proceed to use the password as the authorization and attempt to unlock the storage device 340 with the password. As noted above, when unlocking the storage device 340, the processor and/or the storage application 310 will attempt to use the authorization (the password) to disengage a locking mechanism of the storage device 340. The storage application 310 and/or the processor will attempt to authenticate the authorization by determining whether the password matches a predefined authorization of the storage device. In another embodiment, the storage application 310 and/or the processor will determine whether the password can unlock an encryption of the locking mechanism.

If the password matches the predefined authorization or if the password can be used to unlock an encryption of the locking mechanism, the storage device 340 will become unlocked. If the authentication of the storage device password fails, the user can be prompted to re-enter an authorization or the computing machine 300 can power down. In response to the storage device 340 being unlocked, the storage application 310 and/or the processor proceed to perform a seal operation on the authorization (the password) based on the initial value 375, X, of the platform configuration register 335.

In one embodiment, when performing a seal operation, the storage application 310 and/or the processor instruct the security component 330 to encrypt the authorization (the password) and/or bind the authorization (the password) based on the initial value. 375 X using a storage root key. The storage root key is a key or value used by the security component 330 to encrypt and/or decrypt data or authorizations. Additionally, the storage root key remains on the security component 330 and does not leave the security component 330. Once the authorization (the password) has been sealed by the security component 330, the storage application 310 and/or the processor proceed to store the sealed authorization 325 onto non-volatile memory 345.

In one embodiment, in response to sealing the authorization 325, the storage application 310 and/or the processor will generate an additional random number to update or overwrite the initial value 375 X. By updating or overwriting the initial value 375 X, the sealed authorization 325 can be secured from additional software or applications attempting to access or steal the sealed authorization 325 by unsealing it.

FIG. 3B illustrates a block diagram of a storage application 310 unlocking a storage device 340 in response to a computing machine 300 powering on according to another embodiment. As shown in FIG. 3B, the storage application 310 and/or a processor initially read an initial value 375 of a platform configuration register 375. In one embodiment, the storage application 310 has determined the initial value 375 to be Y. Additionally, the storage application 310 has detected an authorization for the storage device 340 from an input device 390 of the computing machine 300. In another embodiment, the authorization can be detected, unlocked, and/or generated by the storage application 310 and/or the processor.

In response to detecting the authorization, the storage application 310 and/or the processor attempt to unlock the storage device 240 by comparing the authorization to a predefined authorization or decrypting an encryption of the storage device 340 with the authorization. As noted above, in response to successfully unlocking the storage device 340, the storage application 310 and/or the processor will attempt to seal the authorization.

In one embodiment, before sealing the authorization, the processor and/or the storage application 310 will first encrypt the authorization with a key 380. The key 380 is a secret key which can include a sequence of numbers and/or characters which can be used to encrypt and/or decrypt the authorization. When generating the key 380, the storage application 310 can initially generate a random number 365. In one embodiment, the random number 365 generated is Z.

In response to generating the random number 365 Z, the storage application 310 and/or the processor proceed to store Z to a system management memory 360. The system management memory 360 includes an area of memory which stores the random number 365 Z and/or other additional data based on a state of the processor and/or the computing machine 300. In one embodiment, the storage application 310 and/or the processor will then generate the key 380 by executing one or more functions on the initial value 375 X and on the random number 365 Z. In one embodiment, one of the functions can include a key derivative function.

Once the key 380 has been generated, the storage application 310 and/or the processor will proceed to encrypt the authorization with the key 380 to create an encrypted authorization. The processor and/or the storage application 310 will then instruct the security component 330 to seal the encrypted authorization based on the initial value 375 Y using the storage root key of the security component 330. Once the encrypted authorization has been sealed, the sealed authorization 385 will be stored onto non-volatile memory 345.

In another embodiment, the authorization is not encrypted with the key 380. The storage application 310 and/or the processor will alternatively instruct the security component 330 to create a security component key using the key 380. When the security component 330 creates the security component key, a storage root key will not be used for sealing or unsealing. Instead, the security component 330 will use the security component key to seal the authorization based on the initial value 375 X. Once the authorization has been sealed, the sealed authorization 325 will be stored onto the non-volatile memory 345.

In one embodiment, in response to sealing and/or storing the authorization 325, the storage application 310 and/or the processor will generate an additional random number to update or overwrite the initial value 375 X. By updating or overwriting the initial value 375 X, the sealed authorization 325 can be secured from other applications or components attempting to unseal and steal the sealed authorization 325.

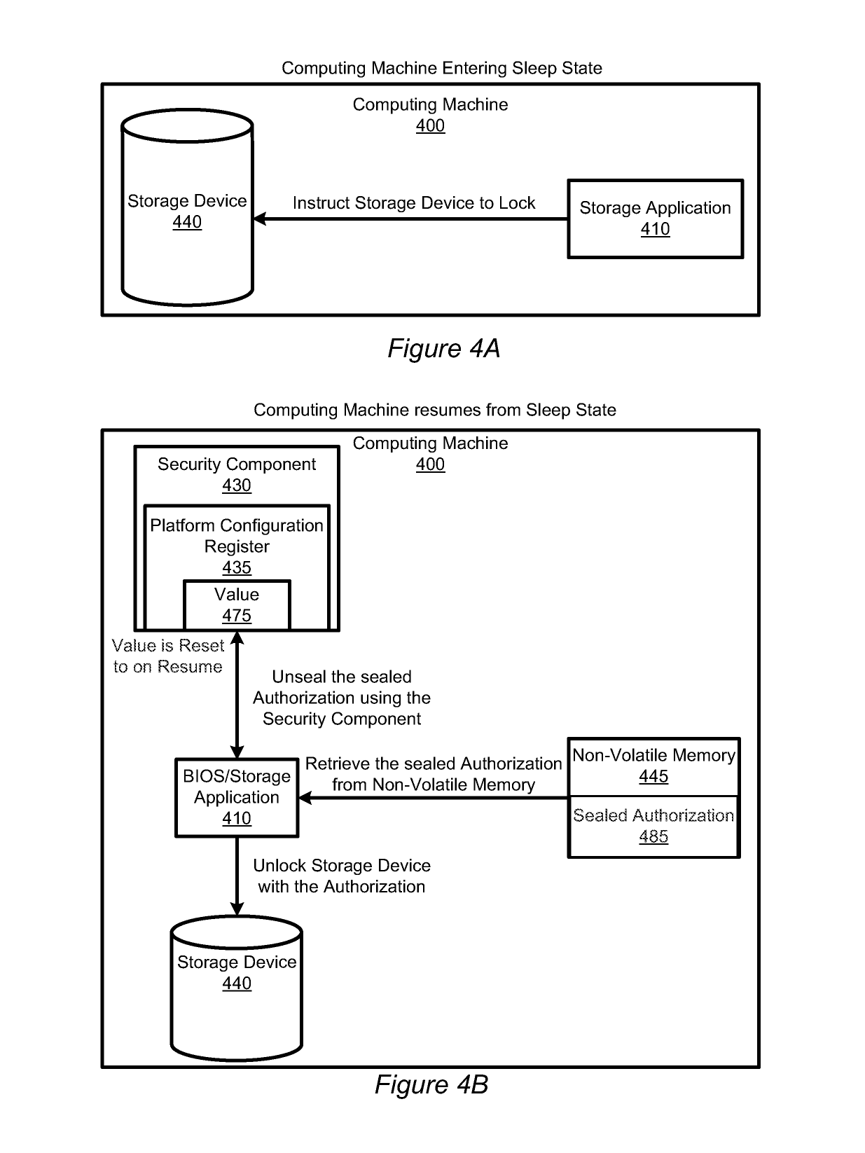

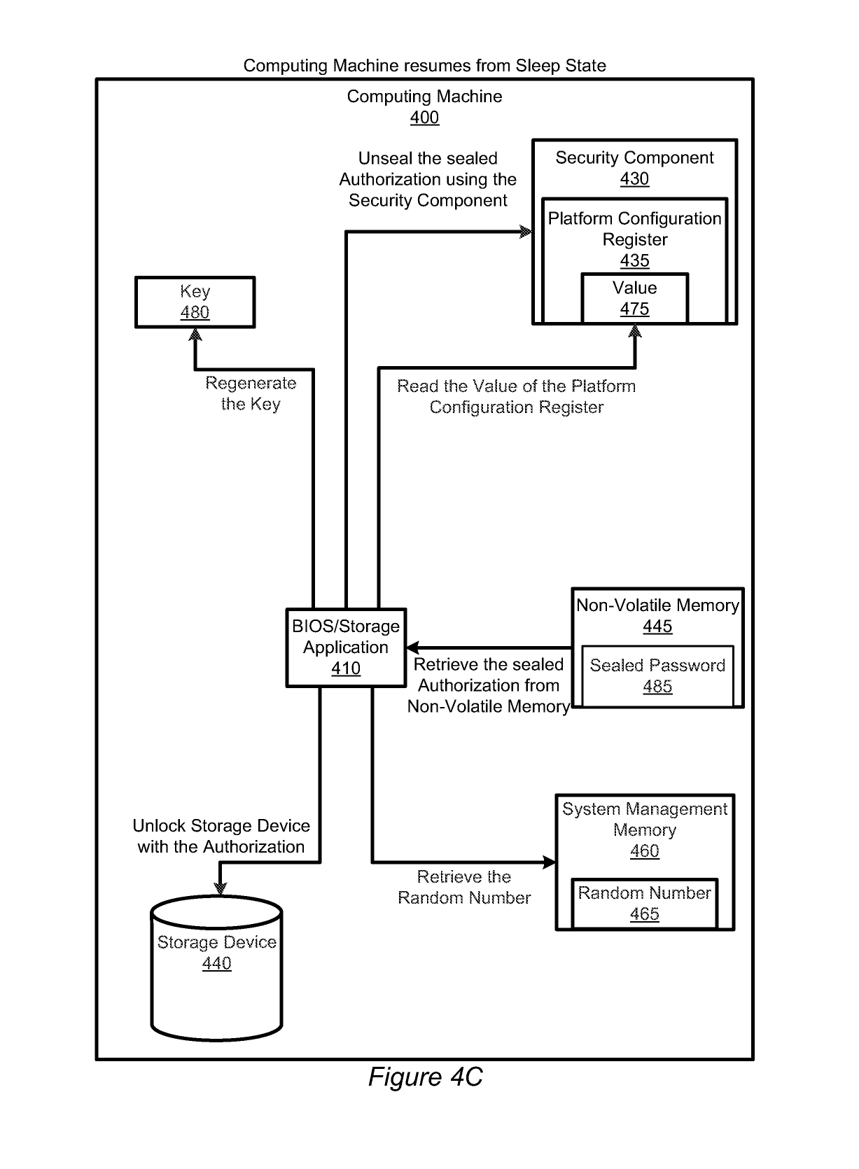

FIG. 4A illustrates a block diagram of a storage device 440 locking in response to a computing machine 400 entering a sleep state according to an embodiment. As noted above, the computing machine 400 can enter and/or transition between one or more power states. The computing machine 400 can enter and/or transition between one or more of the power states automatically or upon instruction from a user or an application.

As noted above, in response to the computing machine 400 entering a sleep state or a power off state, the storage device 440 is configured to lock. The storage device 440 can automatically lock itself or upon instruction by a storage application 410 or a processor of the computing machine 400. In one embodiment, when locking the storage device 440, a locking mechanism of the storage device 440 can engage and prohibit access to content and/or data on the storage device 440. Further, while the computing machine 400 remains in a sleep state, the storage device 440 will remain locked.

FIG. 4B illustrates a block diagram of a storage device 440 unlocking in response to a computing machine 400 resuming from a sleep state according to an embodiment. As noted above, when in a sleep state, the storage device 440 is locked. Additionally, as noted above, a storage application 410 and/or a processor will attempt to unlock the storage device 440 in response to the computing machine 400 resuming from the sleep state.

As illustrated in FIG. 4B, when unlocking the storage device 440, the storage application 410 and/or the processor will retrieve a sealed authorization 485 from the non-volatile memory and attempt to unseal the sealed authorization 485. As noted above, the authorization was previously sealed by the trusted platform module 430 based on the initial value 475 of the platform configuration register 435. As illustrated in FIG. 4B, in response to the computing machine 400 resuming from the state, one or more platform configuration registers 435 are reset to their initial values.

As a result, the initial value 475 of the platform configuration register 435 upon resuming from the sleep state with the same as the initial value 475 of the platform configuration register 435 when the computing machine 400 originally entered the power on state from a power off state. In one embodiment, the storage application 410 and/or the processor proceed to read and identify the initial value 475 of the platform configuration register 435 to be X. The processor and/or the storage application 410 proceed to instruct a security component 430 to unseal the sealed authorization 485 using the storage root key of the security component 430 and based on the initial value 475 X.

As noted above, the security component 430 can include a trusted platform module. In response to the trusted platform module 430 performing the unseal operation on the sealed authorization 485, the storage application 410 and/or the processor will retrieve the authorization. In one embodiment, after the processor and/or the storage application 410 have unsealed the authorization 485, the processor and/or storage application will proceed to update and/or overwrite the initial value 475 of the platform configuration register with a randomly generated number or a predefined number.

As noted above, the authorization can include a password which was previously entered by a user of the computing machine 400. In response to retrieving the password by unsealing the authorization 485, the storage application 410 and/or the processor will then use the password to unlock the storage device 440. When unlocking the storage device 440, the password can be used to decrypt an encryption of a locking mechanism included in the storage device 440 or the password can be used to match a previously defined authorization for the locking mechanism. Once the storage device 440 has been unlocked, the content and/or data of the storage device 440 can be accessed.

FIG. 4C illustrates a block diagram of a storage device 440 unlocking in response to a computing machine 400 resuming from a sleep state according to another embodiment. As illustrated in FIG. 4C, the storage application 410 and/or the processor reads the initial value 475 of the platform configuration register 435 and proceed to retrieve a sealed authorization 485 from non-volatile memory 445. In one embodiment, the storage application and/or the processor have identified the initial value 475 to be Y. In response to retrieving the sealed authorization 485, a security component 430 can be instructed to unseal the sealed authorization 485 based on the initial value 475 Y.

In one embodiment, if the sealed authorization 485 was previously sealed by the security component 430 using a storage root key, the security component 430 will proceed to unseal the sealed authorization 485 based on the initial value 475 Y and using the storage root key. Once the authorization has been unsealed, the storage application 410 and/or the processor can determine if the authorization is encrypted. If encrypted, the storage application 410 and/or the processor can regenerate a key 480 used to unlock the encrypted authorization.

When regenerating the key 480, the storage application 410 and/or the processor will retrieve the random number 365 which was previously generated and stored onto the System Management Memory 360. In one embodiment, the storage application 410 and/or the processor identify the random number 365 to be Z. The storage application 410 and/or the processor will then execute a key derivative function on the random number 365 Z and the initial value 475 Y to regenerate the key 480. Once the key 480 has been regenerated, the storage application 410 decrypts the encrypted authorization using the key 480 to obtain the authorization. The storage device 440 is then unlocked using the authorization.

In another embodiment, if the sealed authorization 485 was previously sealed by the security component 430 using a security component key, the storage application 410 and/or the processor will proceed to regenerate the security component key. In one embodiment, when regenerating the security component key, the storage application 410 and/or the processor will execute a key derivate function on the initial value 475 Y and the random number 465 Z to obtain the key 480. Using the key 480, the security component 430 can regenerate the security component key using the key 480 as an authorization data.

Once the security component key has been regenerated, the security component 430 will proceed to use the security component key to unseal the sealed authorization 485 based on the initial value 475 Y. In response to unsealing the sealed authorization 485, the storage application 410 and/or the processor will retrieve the authorization and proceed to unlock the storage device 440 using the authorization. Additionally, the storage application 410 and/or the processor can proceed to update and/or overwrite the initial value 475 of the platform configuration register 430 as to prevent the sealed password 485 from being unsealed and/or stolen.

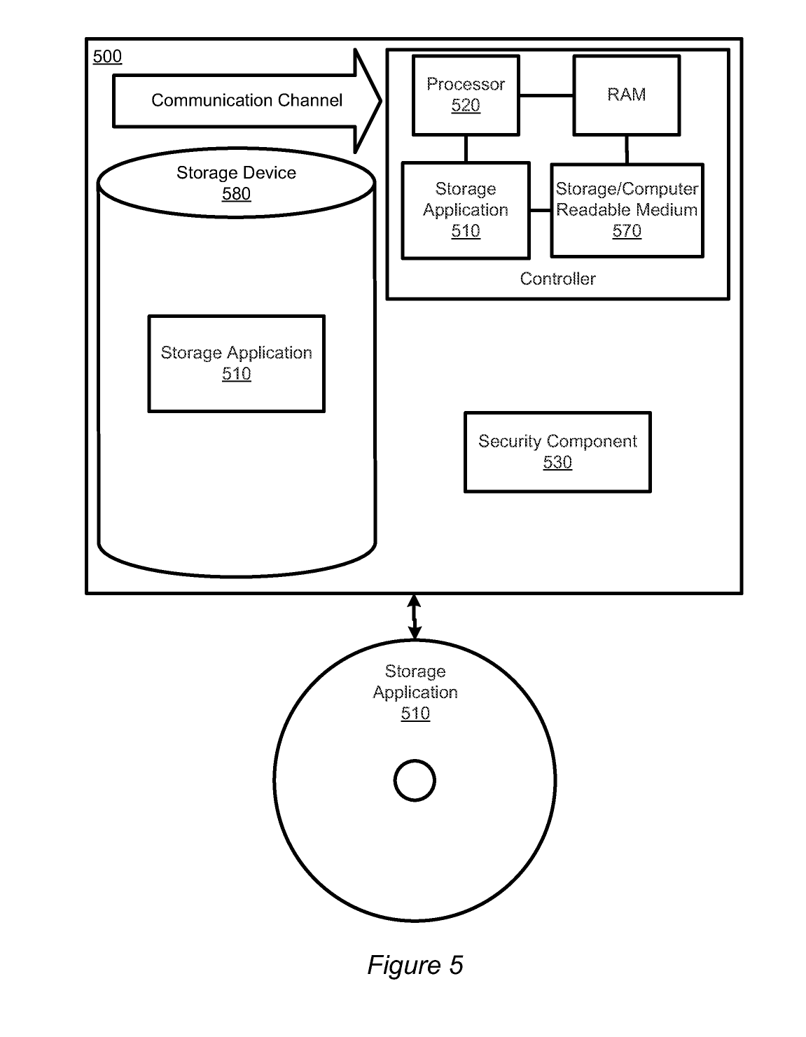

FIG. 5 illustrates a computing machine 500 with a storage application 510 and a storage application 510 stored on a removable medium being accessed by the computing machine 500 according to an embodiment. For the purposes of this description, a removable medium is any tangible apparatus that contains, stores, communicates, or transports the application for use by or in connection with the computing machine 500. As noted above, in one embodiment, the storage application 510 is a BIOS or a firmware that is embedded into one or more components of the computing machine 500 as ROM. In other embodiments, the storage application 510 is a software application which is stored and accessed from a hard drive, a compact disc, a flash disk, a network drive or any other form of computer readable medium that is coupled to the computing machine 500.

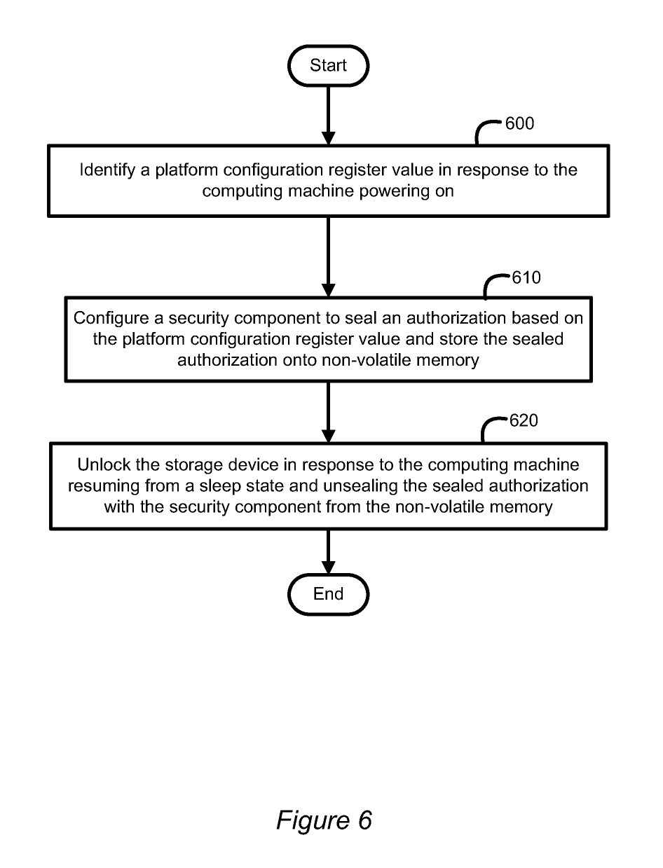

FIG. 6 is a flow chart illustrating a method for unlocking a storage device according to an embodiment. The method of FIG. 6 uses a computing machine with a processor, a security component with at least one platform configuration register, non-volatile memory, a communication channel, a storage device, and a storage application. In other embodiments, the method of FIG. 6 uses additional components and/or devices in addition to and/or in lieu of those noted above and illustrated in FIGS. 1, 2, 3, 4, and 5.

As noted above, the storage application is an application which can independently or in conjunction with the processor manage the storage device. The storage device is an internal or external component of the computing machine configured to store content and/or data. When managing the storage device, the storage application and/or the processor can lock or unlock the storage device in response to the computing machine entering and/or transitioning between one or more power states. As noted above, one or more power states can include a power on state, a power off state, and/or a sleep state.

When the computing machine is in a power off state or a sleep state, the storage device is configured to lock. Additionally, when locked, a locking mechanism of the storage device can be engaged and restrict access to the content and/or data of the storage device. The locking mechanism can include a software, firmware, hardware, and/or a mechanical component. Further, the locking mechanism can be disengaged to unlock the storage device using an authorization. In one embodiment, the computing machine can power on from a power off state to a power on state.

In response to the computing machine powering on, the processor and/or the storage application can access the security component to identify an initial value of a platform configuration register 600. In one embodiment, the security component includes a trusted platform module. As noted above, the platform configuration register is an area of the security component configured to generate one or more values as the computing machine boots. As the computing machine continues a booting process of initializing additional components and loading an operating system, the platform configuration register can continue to generate additional values which are different from the initial value.

In response to reading or identifying the initial value, the processor and/or the storage application will store the initial value to memory. The memory can include volatile or non-volatile memory. In one embodiment, the processor and/or the storage device will additionally identify an authorization used to unlock the storage device. As noted above, the authorization can include a password, a key, and/or any additional authorization secret. Additionally, the authorization can be an encrypted or unencrypted.

In one embodiment, the authorization can be entered as a password by a user using an input device. The input device can include a keyboard, a mouse, a touch panel, a fingerprint scanner and/or an image capture device. In other embodiments, the authorization can be retrieved and/or generated by the processor and/or the storage application executing one or more functions and/or algorithms. In response to identifying an authorization, the processor and/or the storage application will attempt to unlock the storage device.

When unlocking the storage device, the processor and/or the storage application can compare the authorization to a predefined authorization used to engage the locking mechanism. In another embodiment, the authorization can be used to decrypt an encryption of the locking mechanism. If the authorization matches the predefined authorization or if the authorization can be used to decrypt the locking mechanism, the locking mechanism will disengage and the storage device will be unlocked.

In response to the storage device unlocking, the processor and/or the storage device will proceed to use the security component to seal the authorization based on the initial value of the platform configuration register and store the sealed authorization onto non-volatile memory 610. In one embodiment, when sealing the authorization, the security component can seal the authorization using a storage root key of the security component. As noted above, the authorization will be stored based on the initial value of the platform configuration register.

In another embodiment, the processor and/or the storage application will initially generate a key. The key can be generated by the storage application and/or the processor by executing a key derivative function on the initial value of the platform configuration register and a random number generated by the storage application and/or the processor. Using the generated key, the processor and/or the storage device can proceed to encrypt the authorization. The security component can then seal the encrypted authorization using the storage root key and based on the initial value of the platform configuration register.

In another embodiment, the trusted platform module does not use the storage root key to seal the authorization. The security component will use the previously generated key to create a security component key. Using the security component key, the security component will proceed to seal the authorization based on the initial value of the platform configuration register.

Once the authorization has been sealed, the storage application and/or the processor will proceed to store the sealed authorization onto non-volatile memory of the computing machine. The non-volatile memory can include flash memory and/or any internal or external memory which can be coupled to the computing machine. In one embodiment, the processor and/or the storage application update and/or overwrite the initial value of the platform configuration register in response to the sealed authorization being stored onto non-volatile memory.

In response to storing the sealed authorization, the processor and/or the storage application will proceed to determine whether the computing machine is entering a sleep state. If the computing machine is entering into a sleep state, the locking mechanism of the storage device will proceed to automatically engage and lock the storage device. Once the storage device is locked and the computing machine has entered into a sleep state, the storage application and/or the processor will determine and/or detect when the computing machine is resuming from a sleep state. If the computing machine is entering a power on state from a sleep state, the processor and/or the storage application will proceed to unlock the storage device by unsealing the sealed authorization with the security component from the non-volatile memory 620.

The storage application and/or the processor will retrieve the sealed authorization from the non-volatile memory and attempt to use the security component to perform an unseal operation. When unsealing the sealed authorization, the processor and/or the storage application will read the initial value of the platform configuration register again. As noted above, in response to the computing machine resuming from a sleep state, the values generated by the platform configuration register will reset. As a result, when the computing enters the power on state from the sleep state, the platform configuration register will regenerate the initial value.

The processor and/or the storage application will read the initial value generated by the platform configuration register and use the security component to unseal the sealed authorization based on the initial value. In one embodiment, the security component will use the storage root key to unseal the sealed authorization. In another embodiment, the security component will regenerate the security component key to unseal the authorization. Once the authorization has been unsealed, the processor and/or the storage application can decrypt the authorization if the authorization is encrypted.

In response to unsealing and/or decrypting the sealed authorization, the processor and/or the storage application can retrieve the authorization and proceed to use the authorization to disengage the locking mechanism of the storage device. Once the locking mechanism has been disengaged by the authorization matching a predefined authorization or decrypting an encryption of the locking mechanism, the storage device will be unlocked.

In one embodiment, the processor and/or the storage application further overwrite and/or update the initial value of the platform configuration register to prevent the sealed password from being unsealed or stolen. The method is then complete. In other embodiments, the method of FIG. 6 includes additional steps in addition to and/or in lieu of those depicted in FIG. 6.

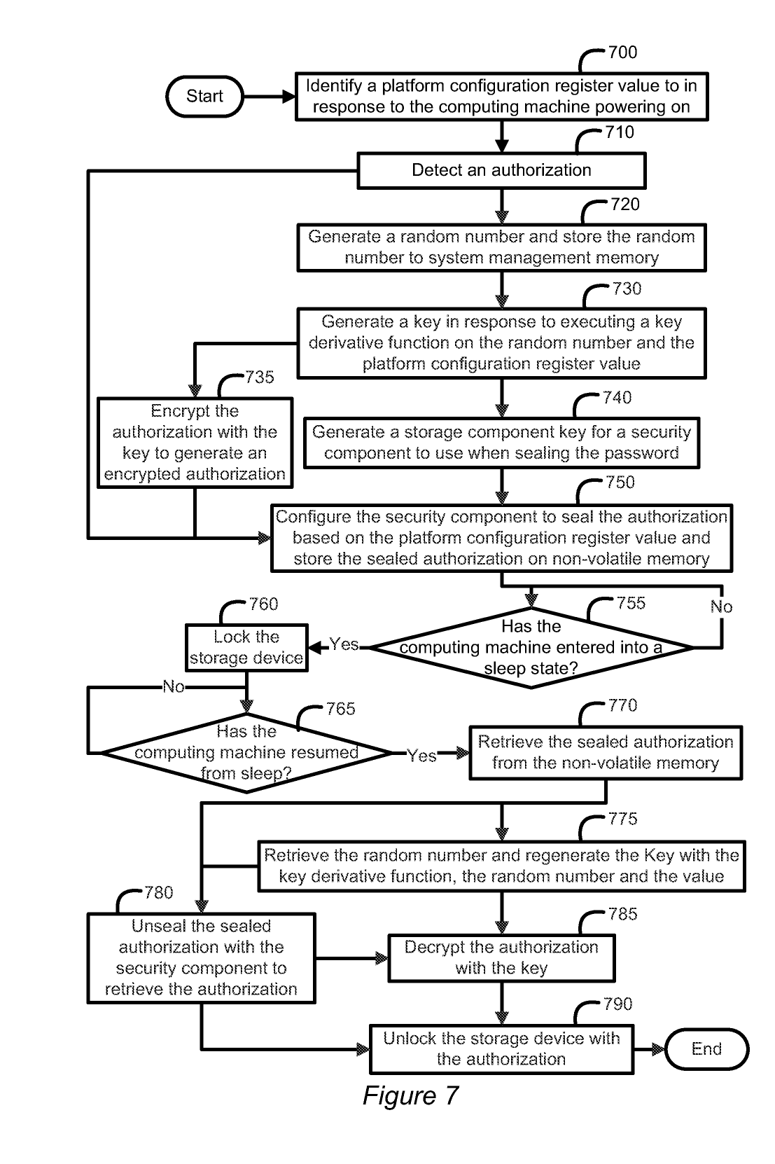

FIG. 7 is a flow chart illustrating a method for unlocking a storage device according to another embodiment. Similar to the method disclosed above, the method of FIG. 7 uses a computing machine with a processor, a security component with at least one platform configuration register, non-volatile memory, a communication channel, a storage device, and an storage application. In other embodiments, the method of FIG. 6 uses additional components and/or devices in addition to and/or in lieu of those noted above and illustrated in FIGS. 1, 2, 3, 4, and 5.

As noted above, in response to the computing machine entering a power on state from a power off state, the processor and/or the storage application initially access a platform configuration module of a security component to identify an initial value 700. The security component is a software or hardware component of the computing machine configured to generate cryptographic keys used to protect and/or seal data and authorizations. In one embodiment, the security component is or includes a trusted platform module. The platform configuration register generates a value base on the state of the computing machine. As the computing machine continues a boot process, the platform configuration generates additional values.

In response to identifying an initial value of the platform configuration register, the processor and/or the storage device will store the initial value to memory of the computing machine. Once the initial value has been stored to memory, the processor and/or the storage application will detect an authorization through an input device of the computing machine 710. The authorization can be a password which includes one or more sequence of characters and/or numbers. In another embodiment, the processor and/or the storage application can generate an authorization using one or more keys, functions, and/or algorithms.

Once an authorization has been detected, identified, and/or generated, the authorization can be used to unlock the storage device. As noted above, the storage device can default into a locked state when the computing machine is in a power off state or a sleep state. When unlocking the storage device, the processor and/or the storage application can compare the authorization to a predefined authorization used to engage a locking mechanism of the storage device. If the authorization matches the predefined authorization or can be used to decrypt an encryption of the locking mechanism, the locking mechanism will disengage and the storage device will become unlocked.

In one embodiment, the storage application and/or the processor will then proceed to use the security component to seal the authorization based on the initial value of the platform configuration register and store the sealed authorization onto non-volatile memory 750. When sealing the authorization, the security component can use a storage root key to encrypt the storage device password based on the initial value.

In another embodiment, when sealing the authorization, the storage application and/or the processor can initially generate a random number and store the random number to a system management memory 720. The processor and/or the storage application will then execute a key derivative function on the random number and the initial value of the platform configuration register to generate a key 730. Using the key, the processor and/or the storage device can encrypt the authorization to create an encrypted authorization 735. The security component will then seal the encrypted authorization using the storage root key and based on the initial value of the platform configuration register and store the sealed authorization to non-volatile memory 750.

In another embodiment, the storage application and/or the processor does not use the key to encrypt the authorization. Instead, the key is used by the security component to generate a security component key 740. The security component key is used instead of the storage root key to seal the authorization based on the initial value of the platform configuration register and the sealed authorization is then stored to non-volatile memory 750. As noted above, the processor and/or the storage application can generate an additional random number and proceed to overwrite and/or update the initial value of the platform configuration register to prevent to the sealed password from being accessed or stolen by another software or application.

Once the sealed authorization has been stored, the processor and/or the storage application will determine whether the computing machine is entering a sleep state 755. If the computing machine is not detected to enter into a sleep state, the processor and/or the storage application will continue to detect for the computing machine entering the sleep state 755. If the computing machine is detected to be entering the sleep state, the storage device will proceed to lock 760. As noted above, the locking mechanism can be configured to automatically engage to lock the storage device. In another embodiment, the storage application and/or the processor can instruct the locking mechanism to engage and lock the storage device in response to the computing machine entering the sleep state.

Once the storage device has locked, the processor and/or the storage application will determine whether the computing machine is resuming to a power on state from a sleep state 765. If the computing machine is not resuming to a power on state, the processor and/or the storage device will continue to detect for the computing machine resuming 765. If the computing machine is detected to be resuming to a power on state, the processor and/or the storage application will attempt to unlock the storage device.

When unlocking the storage device, the processor and/or the storage application will retrieve the previously stored sealed authorization from the non-volatile memory 770. Additionally, the processor and/or the storage application will access the platform configuration register again to identify the initial value. Because the computing machine is resuming from a sleep state, the current initial value of the platform configuration register will be the same as when the computing machine initially powered on from a power off state.

In one embodiment, if the sealed authorization was previously not encrypted and the security component sealed the authorization using the storage root key, the security component will proceed to unseal the sealed authorization using the storage root key and based on the initial value 780. In response, the authorization will be retrieved to disengage the locking mechanism and unlock the storage device 790.

In another embodiment, if the sealed authorization was previously encrypted and sealed using the storage root key, the processor and/or the storage application will regenerate the key. When regenerating the key, the processor and/or the storage application will retrieve the random number stored from system management memory and execute a key derivative function on the random number and the initial value of the platform configuration register 775.

Once the key has been regenerated, the security component will unseal the sealed authorization using the storage root key and based on the initial value of the platform configuration register 780. In response to unsealing the authorization, the processor and/or the storage application will decrypt the encrypted authorization using the regenerated key to obtain the authorization 785. Using the authorization, the storage application and/or the processor will disengage the locking mechanism and unlock the storage device 790.

In other embodiments, if the sealed authorization was previously sealed using a security component key, the security component will regenerate the security component key and use the security component key to unseal the sealed authorization based on the initial value of the platform configuration register 780. Using the unsealed authorization, the storage application and/or the processor will disengage the locking mechanism and unlock the storage device 790. The method is then complete. In other embodiments, the method of FIG. 7 includes additional steps in addition to and/or in lieu of those depicted in FIG. 7 to unlock a storage device.

What is claimed is:

1. A method for unlocking a storage device comprising:
identifying a platform configuration register value in response to a computing machine powering on;
configuring a security component to seal an authorization based on the platform configuration register value and storing a sealed authorization onto non-volatile memory; and
unlocking the storage device in response to the computing machine resuming from a sleep state and unsealing the sealed authorization with the security component from the non-volatile memory.

2. The method for unlocking a storage device of claim 1 further comprising detecting a user inputting the authorization.

3. The method for unlocking a storage device of claim 2 further comprising storing a random number generated by a BIOS of the computing machine onto a system management memory.

4. The method for unlocking a storage device of claim 3 further comprising generating a key in response to executing a key derivative function with the random number and the platform configuration register value.

5. The method for unlocking a storage device of claim 4 wherein the authorization is encrypted with the key.

6. The method for unlocking a storage device of claim 5 further comprising regenerating the key in response to the computing machine resuming from the sleep state.

7. The method for unlocking a storage device of claim 6 wherein unlocking the storage device includes decrypting the authorization with the key.

8. The method for unlocking a storage device of claim 4 further comprising generating a security component key for the security component to use when sealing the authorization.

9. The method for unlocking a storage device of claim 8 wherein unlocking the storage device includes the security component unsealing the authorization with the security component key to retrieve the authorization.

10. A computing machine comprising:
a security component to seal an authorization to non-volatile memory based on a platform configuration register value;
a storage device to lock in response to the computing machine entering a sleep state; and
a processor to resume the computing machine from the sleep state and unlock the storage device in response to the security component unsealing the authorization from the non-volatile memory.

11. The computing machine of claim 10 wherein the computing machine resumes from a S3 power state when resuming from the sleep state.

12. The computing machine of claim 10 further comprising an input device configured to detect a user entering the authorization used to unlock the storage device.

13. A computer-readable program in a computer-readable medium comprising:
a storage application to store a platform configuration value of a security component to a memory in response to a computing machine powering on;
wherein the storage application is configured to instruct the security component to seal an authorization based on the platform configuration register value; and
wherein the security component is configured to unseal the authorization to unlock a storage device of the computing machine in response to the computing machine resuming from a sleep state.

14. The computer-readable program in a computer-readable medium of claim 13 wherein the storage application is configured to identify a password and the storage component is configured to seal the password as the authorization.

15. The computer-readable program in a computer-readable medium of claim 14 wherein unlocking the storage device includes unsealing the authorization to obtain the password and utilizing the password to unlock the storage device.
